(19) United States
(12) Patent Application Publication
(10) Pub. No.: US 2016/0337161 A1
(43) Pub. Date: Nov. 17, 2016

(54) METHOD AND APPARATUS FOR FACILITATING COMMUNICATION BETWEEN DEVICES

(71) Applicant: Andrew G. Huibers, Sunnyvale, CA (US)

(72) Inventor: Andrew G. Huibers, Sunnyvale, CA (US)

(73) Assignee: BUMP TECHNOLOGIES, INC., Mountain View, CA (US)

(21) Appl. No.: 13/346,187

(22) Filed: Jan. 9, 2012

(51) Int. Cl. G06F 15/173

(52) U.S. Cl. CPC H04L 29/06333

(57) ABSTRACT

Some embodiments described in this disclosure provide methods and/or systems to facilitate communication between devices. A first device may detect a first event based on an action performed by a user using the first device. The first device may then send information of the first event to a server. The server can then attempt to match the first event with an event from a set of events based on the information of the first event. The first device may receive a response from the server that indicates whether or not the first event matched a second event that was sent to the server from a second device.

### BACKGROUND

This disclosure relates to communication devices. Setting up a communication session between two devices (e.g., two smartphones) is often cumbersome. Therefore, what are needed are methods and systems for facilitating communication between devices.

### SUMMARY

Some embodiments described in this disclosure provide methods and/or systems to facilitate communication between devices. A first device may detect a first event based on an action performed by a user using the first device. The first device may then send information of the first event to the server. In some embodiments, the information of the first event can include: temporal information, spatial information, and additional information that is neither temporal nor spatial. The first device may receive a response from the server that indicates whether or not the first event matched a second event that was sent to the server from a second device. Specifically, if the response indicates that the server was unable to find a matching event for the first event, then the response may further indicate why a suitable match was not found. For example, the response may specify that the first event did not match any events at the server, or that the first event matched two or more events at the server.

The temporal information (e.g., a time value from a global or local clock) can indicate when the first event occurred, and the spatial information (e.g., longitude and latitude coordinates from a global positioning system receiver) can indicate a location of the first device when the first event occurred. The additional information that is neither temporal nor spatial can generally include any information that: (1) does not explicitly indicate when the first event occurred, (2) does not explicitly indicate a location of the first device when the first event occurred, and (3) is capable of being used to detect a user's intention to communicate with another device. Specifically, in some embodiments, the additional information that is neither temporal nor spatial is used to adjust a probability value that is computed based on the temporal and spatial information, wherein the probability value indicates the probability that the user intends to communicate with another device.

For example, the additional information that is neither temporal nor spatial can include, but is not limited to, (1) information of a type of hardware used in the first device; (2) information of a type of operating system used in the first device; (3) information of a communication service provider used by the first device to communicate with the server; (3) information of an identifier associated with a communication channel (e.g., an SSID of a WiFi network) used by the first device to communicate with the server; (4) information of a node in a social network associated with the user; (5) information of an ambient temperature that was recorded when the first event occurred; (6) contact information from an address book associated with the user; and/or (7) an ambient sound recording that was recorded when the first event occurred.

In some embodiments described herein, a server can receive information of a first event from a first device, wherein the first event indicates that a user of the first device intends to communicate with another device. The server can then attempt to match the first event with an event from a set of events based on the information of the first event. Next, the server can determine whether the first event matched a matched event or an unmatched event. If the first event matched an unmatched event, the server can send a response to the first device indicating that the first event was successfully matched. On the other hand, if the first event matched a matched event, the server can send a response to the first device indicating that the first event was not matched. According to one definition, an unmatched event is an event in the set of events that had not been matched with another event prior to receiving the information of the first event, and a matched event is an event in the set of events that had already been matched with another event prior to receiving the information of the first event.

In some embodiments, if the first event does not match any event from the set of events, the server can add the first event to the set of events.

In some embodiments, if the first event does not match any event from the set of events, the server can determine a set of devices based on the temporal and spatial information, and send a query to each device in the set of devices. In some embodiments, the server can start a timer to wait for responses from at least a subset of the set of devices responsive to the first event not matching any event from the set of events. The responses from the devices can indicate whether or not a device that sent the response has an event that matches the first event.

### BRIEF DESCRIPTION OF THE FIGURES

FIG. 1 illustrates a system in accordance with some embodiments described herein.

FIG. 2 presents a flowchart that illustrates a process for processing events in accordance with some embodiments described herein.

FIG. 3 presents a flowchart that illustrates a process that may be performed at a server in accordance with some embodiments described in this disclosure.

FIG. 4 presents a flowchart that illustrates a process that may be performed at a device in accordance with some embodiments described herein.

FIG. 5 presents a flowchart that illustrates a process that may be performed at a device in accordance with some embodiments described herein.

FIG. 6 illustrates an example of event information in accordance with some embodiments described herein.

FIG. 7 illustrates a computer in accordance with some embodiments described herein.

FIG. 8 illustrates an apparatus in accordance with some embodiments described herein.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention.

Thus, the present invention is not limited to the embodiments shown, but is to be accorded the widest scope consistent with the principles and features disclosed herein.

The data structures and code described in this detailed description are typically stored on a non-transitory storage medium, which may be any tangible device or medium that can store code and/or data for use by a computer system. A non-transitory storage medium includes all storage mediums with the sole exception of a propagating electromagnetic wave or signal. Specifically, a non-transitory storage medium includes, but is not limited to, volatile memory, non-volatile memory, magnetic and optical storage devices such as disk drives, magnetic tape, CDs (compact discs), DVDs (digital versatile discs or digital video discs), or other tangible media, now known or later developed, that is capable of storing information.

The methods and processes described in the detailed description section can be embodied as code and/or data, which can be stored in a non-transitory storage medium as described above. When a computer system reads and executes the code and/or data stored on the non-transitory storage medium, the computer system performs the methods and processes embodied as data structures and code and stored within the non-transitory storage medium.

Furthermore, the methods and processes described below can be included in hardware modules. For example, the hardware modules can include, but are not limited to, application-specific integrated circuit (ASIC) chips, field programmable gate arrays (FPGAs), and other programmable-logic devices now known or later developed. When the hardware modules are activated, the hardware modules perform the methods and processes included within the hardware modules.

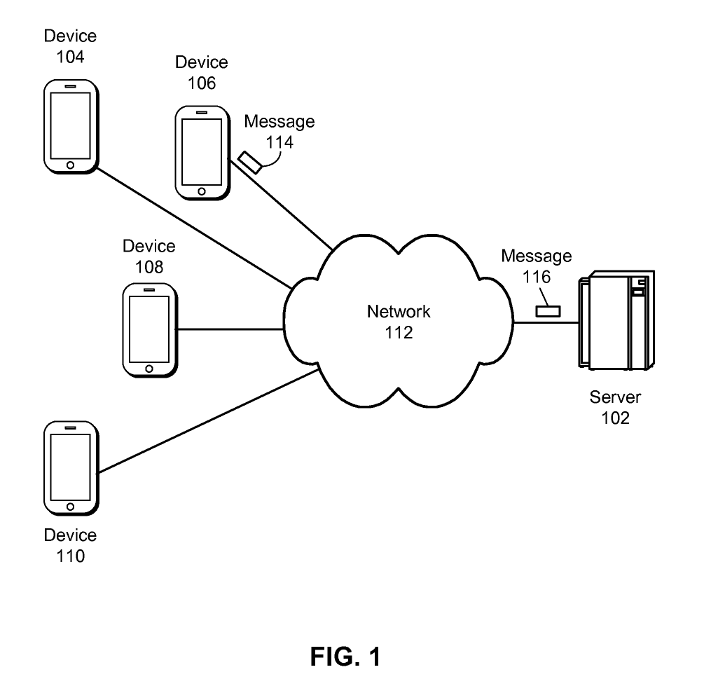

FIG. 1 illustrates a system in accordance with some embodiments described herein.

Devices 104-110 can communicate with each other and/or with server 102 via network 112. In some embodiments described herein, a device (e.g., devices 104-110) can generally be any hardware-based device, now known or later developed, that is capable of communicating with other devices. Examples of devices can include, but are not limited to, desktop computers, laptop computers, handheld computing devices, tablet computing devices, smartphones, automatic teller machines, point of sale systems, etc.

In some embodiments described herein, a device may include one or more mechanisms to detect an event that indicates that a user intends to communicate with another device. Specifically, a device may include one or more inertial sensors (e.g., an accelerometer, gyroscope, etc.) which may be capable of detecting a user gesture that indicates that the user desires to communicate with another device. For example, a user may shake his or her device in proximity to another device to indicate his or her intent to communicate with the other device. As another example, the user may tap the screen of the smartphone or speak into the microphone of the smartphone to indicate his or her intent to communicate. In some embodiments described herein, when the device detects an event that indicates that the user intends to communicate with another device, the device can record the time the event occurred, the location of the device when the event occurred, and/or any other parameter values that may be used to detect an intent to establish a communication channel between two or more devices. In some embodiments, a camera can be used to detect motion. In some embodiments, a magnetometer can be used to sense orientation.

Network 112 can generally include any type of wired or wireless communication channel, now known or later developed, that enables two or more devices to communicate with one another. Network 112 can include, but is not limited to, a local area network, a wide area network, or a combination of networks.

Server 102 can generally be any system that is capable of performing computations and that is capable of communicating with other devices. Server 102 can be a computer system, a distributed system, a system based on cloud computing, or any other system, now known or later developed, that is capable of performing computations.

Once a device detects an event, the device can send a message to a server. For example, device 106 can send message 114 to server 102 through network 112. In response, server 102 can send message 116 to device 106. In this disclosure, the term “message” generally refers to a group of bits that are used for conveying information. In connection-oriented networks, a message can be a series of bits. In datagram-oriented networks, a message can include one or more units of data, e.g., one or more packets, cells, or frames.

Message 116 may indicate whether or not server 102 was able to match the event that was received from device 106 with another event that was received from another device. Clocks at different devices may not be synchronized and the location data may not be precise. Consequently, the matching process used by server 102 may need to account for any systematic and/or random variability present in the temporal or spatial information received from different devices.

After events from two devices are matched with each other, the two devices may exchange further information (e.g., contact information, pictures, etc.) with each other. In some embodiments described herein, the subsequent information exchange may be routed through the server that matched the events from the two devices. In other embodiments, the subsequent information exchange may occur directly over a communication session that is established between the two devices. Information exchanged between two communicating nodes (e.g., devices, servers, etc.) may be performed with or without encryption and/or authentication.

Further embodiments of methods and systems for facilitating communication between devices can be found in (1) U.S. application Ser. No. 12/699,692, entitled “Bump validation,” by inventor Andrew G. Huibers, filed on 3 Feb. 2010, the contents of which are herein incorporated by reference, and (2) U.S. application Ser. No. 12/730,091, entitled “Bump suppression,” by inventor Andrew G. Huibers, filed on 23 Mar. 2010, the contents of which are herein incorporated by reference.

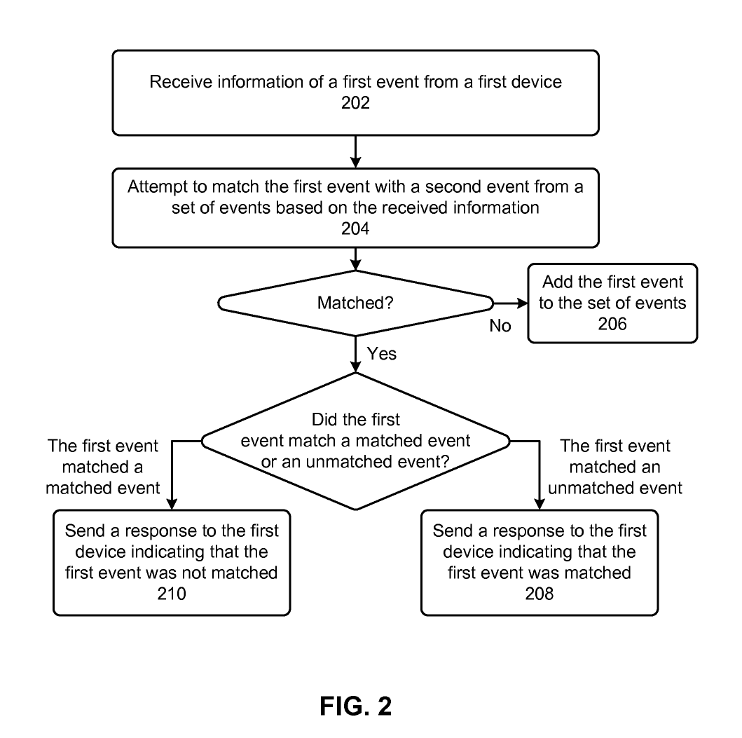

FIG. 2 presents a flowchart that illustrates a process for processing events in accordance with some embodiments described herein. The process shown in FIG. 2 may be performed by server 102.

The process can begin with receiving information of a first event from a first device (operation 202). For example, server 102 can receive message 114 which may contain information of an event that was detected by device 106.

Next, an attempt can be made to match the first event with a second event from a set of events based on the received information (operation 204). A variety of criteria may be used to match two events. If no matching event is found within a predetermined time period, the device may be notified accordingly.

For example, in some embodiments described herein, the server may compute a score for each event in the set of events and select the event that has a maximal (highest or lowest) score as the matching event. In some embodiments described herein, the server may determine that none of the events in the set of events match the first event if the maximal score is below a threshold, and/or if multiple events have a substantially maximal score.

If no matching event is found, the first event may be added to the set of events (operation 206). On the other hand, if a matching event is found, the system can perform different operations depending on whether the first event matched an event that had already been matched, or whether the first event matched an unmatched event.

If the first event matched an unmatched event, a response can be sent to the first device indicating that the first event was matched (operation 208). On the other hand, if the first event matched a matched event, a response can be sent to the first device indicating that the first event was not matched (operation 210).

For example, suppose server 102 receives event E1 from device 104. Server 102 may maintain a set of events that are used for matching incoming events. This set of events can be determined based on a variety of factors. Specifically, in some embodiments, the set of events can include all events that were received within a given time window. If event E1 does not match any of the events in the set of events, then server 102 may place event E1 in the set of events. If event E1 matches event E2 in the set of events, and if this is the first time event E2 has matched another event, then server 102 can conclude that event E1 has matched an unmatched event, and can send a response to device 104 accordingly. On the other hand, if event E1 matches event E2 in the set of events, and if this is not the first time event E2 has been matched (e.g., event E2 matched event E3 that was received before E1), then server 102 can conclude that event E1 has matched a matched event, and send a response to device 104 accordingly.

In some embodiments, a server may send a set of queries to a set of devices when an event is received to determine whether or not the set of devices sent an event (which is likely to match the received event) to the server.

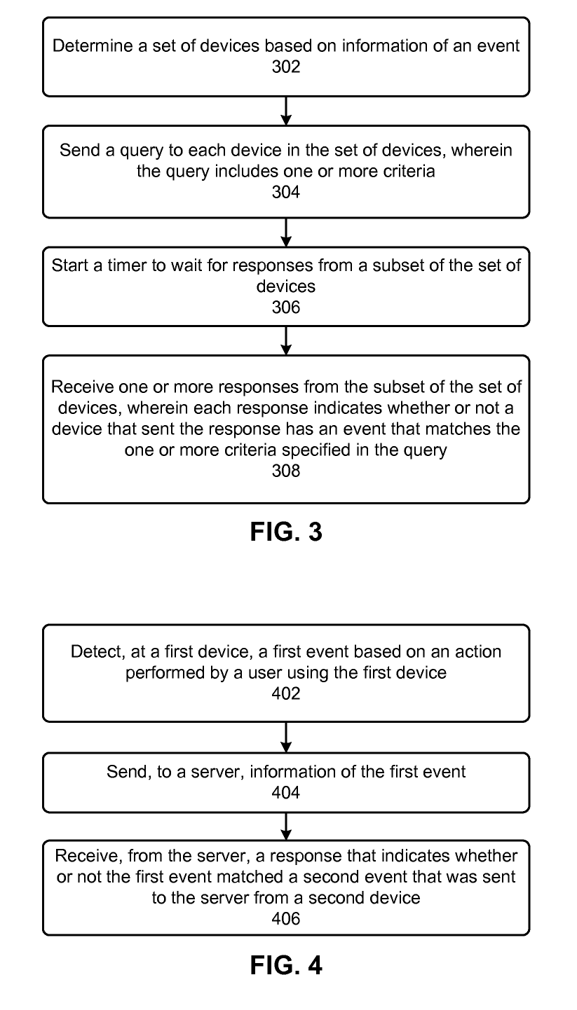

FIG. 3 presents a flowchart that illustrates a process that may be performed at a server in accordance with some embodiments described in this disclosure.

The process may begin with determining a set of devices based on information of an event (operation 302). In some embodiments described herein, the set of devices may be determined based on the spatial information included in the event. For example, suppose a server receives event E1 from device D1. The server may select devices whose expected locations are within a given distance from the expected location of device D1. The distance that is used to select the set of devices can be a predetermined value and/or may be computed based on a variety of factors, e.g., the type of device, the density of devices (e.g., the number of devices per unit area in proximity to device D1), etc.

Once a set of devices has been determined, a query can be sent to each device in the set of devices, wherein the query includes one or more criteria (operation 304). Next, a timer can be started to wait for responses from a subset of the set of devices (operation 306). In some embodiments, the subset of the set of devices may be equal to the set of devices. The system (e.g., server 102) can then receive one or more responses from the subset of the set of devices, wherein each response indicates whether or not a device that sent the response has an event that matches the one or more criteria specified in the query (operation 308). In some embodiments, if the timer expires or the system receives a response to the query from all of the devices in the subset of the set of devices, the system can send a response to device indicating whether or not the event was successfully matched.

For example, suppose a server receives event E1 from device D1. The server can send a query to a set of devices in proximity to device D1, and start a timer to wait for responses to the query. The one or more criteria in the query can generally include any information that the recipient device can use to filter and/or identify events. For example, in this example, the query can include the time when event E1 occurred. A recipient device, say D2, can use the time information in the query to determine if D2 detected an event around the same time as E1. The device D2 can then send a response to the server accordingly. For example, if device D2 determines that one or more events match the specified criteria, device D2 can include the information of the matching events in the response. On the other hand, if device D2 determines that no events match the specified criteria, then device D2 can send an empty response (i.e., a response with zero events) and/or include an explicit indication in the response that no matching events were found. If the timer expires or if the server receives a sufficient number of responses to the query, then the server can send a message to device D1 that indicates whether or not event E1 was successfully matched.

FIG. 4 presents a flowchart that illustrates a process that may be performed at a device in accordance with some embodiments described herein.

The process can begin with detecting, at a first device, a first event based on an action performed by a user using the first device (operation 402). For example, the first device may detect an event if a measurement from a sensor (or a combination of measurements from multiple sensors) exceeds a threshold.

Next, the first device can send information of the first event to a server (operation 404). In some embodiments described herein, the first device can send, to the server, a message that includes temporal information of first event (e.g., the time the event occurred) and spatial information of the first event (e.g., the location of the first device when the event occurred).

The first device can then receive, from the server, a response that indicates whether or not the first event matched a second event that was sent to the server from a second device (operation 406). For example, the response may include a field that specifies whether or not a match occurred. Additional fields in the response may contain information that may help establish a connection with the matching device (e.g., a network address of the matching device) and/or information as to why a match was not found (e.g., multiple matches were found which caused a collision).

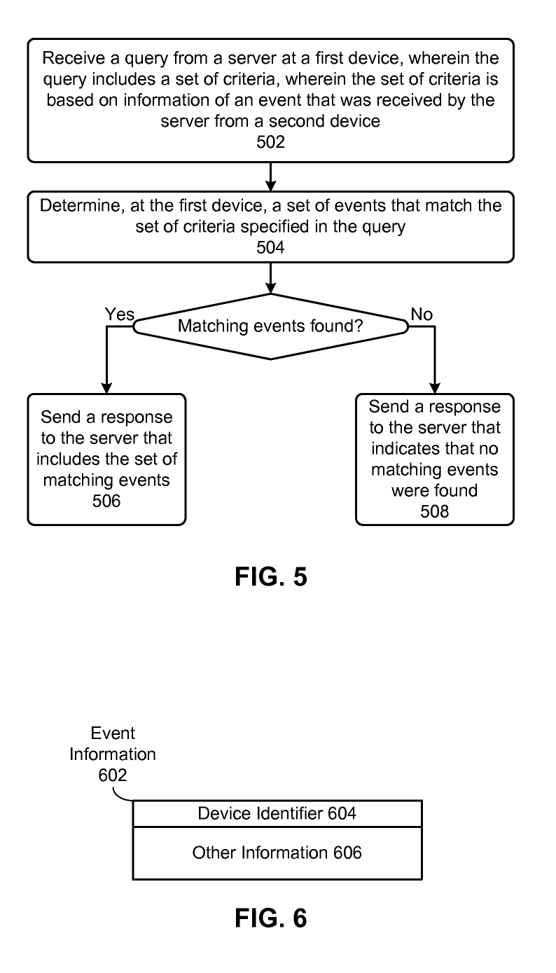

FIG. 5 presents a flowchart that illustrates a process that may be performed at a device in accordance with some embodiments described herein.

The process can begin with receiving a query from a server at a first device, wherein the query includes a set of criteria, wherein the set of criteria is based on information of an event that was received by the server from a second device (operation 502).

Next, the first device can determine a set of events that match the set of criteria specified in the query (operation 504).

For example, the set of criteria may include the time an event occurred, e.g., time T1, on the second device, and the first device can use this information to identify an event that occurred at the first device within a predefined time window around time T1. As another example, the set of criteria may include (in lieu of or in addition to the time information) a sound recording or a fingerprint of a sound recording which can then be used to identify a set of matching events that occurred at the first device. A fingerprint of a sound recording can generally be any value that is derived from the sound recording data. For example, a fingerprint can be a list of frequencies and normalized amplitudes of the top N frequency components.

If matching events are found, the first device can send a response to the server that includes the set of matching events (operation 506). On the other hand, if no matching events are found, the first device can send a response to the server that indicates that no matching events were found (operation 508).

FIG. 6 illustrates an example of event information in accordance with some embodiments described herein.

Event information 602 can generally include any information that can be used to match two or more events with one another. In some embodiments described herein, event information 602 can include device identifier 604 and other information 606.

In some embodiments described herein, event information 602 may include information that is formatted in a type-length-value (TLV) format. In the TLV format, a piece of information is specified using three fields: a type field which specifies the type information (e.g., hardware identifier, software identifier, etc.), a length field which specifies the length of the information (e.g., the number of bytes), and a value field which contains the information itself

Device identifier 604 can generally be any group of bits that uniquely identify a device to the server for purposes of matching events. Specifically, device identifier 604 can include a hardware identifier, a network address (e.g., an IP or Ethernet address), and/or a combination of multiple identifiers (e.g., a combination of a hardware platform type field, an operating system version, a hardware identifier, and/or a network address).

Other information 606 can generally include any information that can be used to detect the intent of two users to communicate with each other. Examples of fields that may be part of other information 606 can include, but are not limited to, (1) a hardware identifier, e.g., a freeform alphanumeric field that corresponds to a device model and/or a hardware manufacturer; (2) a software identifier, e.g., a freeform alphanumeric field that corresponds to a software type, implementation, vendor, and/or version; (3) a network address, e.g., an IP or Ethernet address; (4) a carrier identifier, e.g., a field that indicates a communication company whose network the device is using; (5) a network identifier, e.g., an identifier (e.g., the SSID of a WiFi network) that corresponds to the communication network that the device is using; (6) a node identifier in a social network, e.g., the name or website of the social network (e.g., www.facebook.com) combined with the user name or user identifier that is used in the social network; (7) a list of locations of the device over a predefined time period; (8) ambient temperature; (9) one or more phone numbers (e.g., the device's phone number and/or phone numbers associated with the owner of the device) stored on the device, or representations thereof, such as hashes or Bloom filters; and/or (10) a count of events that were detected over a given time period.

An event can be matched with other events based on a variety of factors. In general, the matching process can receive information of two or more events, and can output one or more pairs of events. For example, the matching process may receive information for events E1, E2, E3, E4, E5, E6, and E7, and the matching process may output the following three pairs of events: (E1, E6), (E1, E4), (E5, E7). Note that some of the events may match exactly one other event (e.g., events E5 and E7 only match each other), while other events may have multiple matches (e.g., event E1 matches events E6 and E4). Furthermore, some events may not match any other events (e.g., events E2 and E3 do not match any other events).

In some embodiments described herein, the matching process can receive a single event, e.g., event E7, which is then matched against a set of events, e.g., {E1, E2, E3, E4, E5, E6}. In these embodiments, the matching process may output one or more matching pairs depending on the configuration. For example, if the matching process is configured to output only one match, then the matching process may select the event from the set of events that is the best match. On the other hand, if the matching process is configured to output one or more matches, then the matching process may select all events from the set of events that match the given event based on one or more thresholds, rules, and/or criteria.

In some embodiments, the matching process can determine matching events based on computing matching scores, wherein each matching score is computed based on event information of a pair of events. The matching score can be an absolute score, a relative score, and/or a combination thereof.

An absolute matching score for events E1 and E2 can be a value that depends only on the event information of events E1 and E2. For example, an absolute matching score for events E1 and E2 can be computed as follows: (1) represent events E1 and E2 as two points in a multidimensional space based on the event information of the two events, and (2) compute the absolute matching score based on the distance between the two points.

A relative matching score for events E1 and E2, on the other hand, can be a value that depends on the event information of a set of events that include other events in addition to events E1 and E2. For example, a relative matching score for events E1 and E2 can be computed as follows: (1) compute an absolute matching score for a set of event pairs, (2) rank the event pairs based on their absolute matching scores, and (3) compute a relative matching score for event pair (E1, E2) based on the rank of event pair (E1, E2).

These examples of absolute and relative matching scores have been presented only for purposes of illustration. Many modifications and variations will be apparent to practitioners having ordinary skill in the art. For example, in one variation, a matching score can be computed as follows: (1) compute an absolute matching score (e.g., based on a first set of parameters), (2) compute a relative matching score (e.g., based on a second set of parameters), and (3) compute a final score by combining the absolute score and the relative score (e.g., by computing a weighted sum of the absolute and relative scores).

In some embodiments, the matching score can be computed as follows: (1) determine a function for each event based on the event information, and (2) compute a matching score based on the functions. For example, in some embodiments, a location function and a time function can be computed for each event. In some embodiments, the location function for an event can be the probability distribution function of the location of the device, and the time function can be the probability distribution function of the time when the event occurred.

Note that a given parameter (e.g., location or time) in the event information may contain systematic and/or random variations. The probability distribution function for the parameter may be selected to represent this variation. For example, if the location information was generated by a highly accurate technique, then the probability distribution function of the location may be represented by a narrow Gaussian function that is centered at the reported location of the device. On the other hand, if the location information was generated by a technique that has low accuracy, then the probability distribution function of the location may be represented by a wide Gaussian function that is centered at the reported location of the device.

The system can create one or more functions based on the event information. In some embodiments, the system can create a multidimensional function that covers multiple parameters. For example, a two-dimensional Gaussian function can be created, where one dimension corresponds to location and the other dimension corresponds to time.

In some embodiments described herein, once the functions corresponding to events E1 and E2 have been determined, the matching score can be computed as follows: (1) compute a spatial component by determining an amount of overlap between the location functions of events E1 and E2, (2) compute a temporal component by determining an amount of overlap between the time functions of events E1 and E2, and (3) compute the matching score based on the spatial component and the temporal component.

An amount of overlap between two functions can generally indicate an extent to which the plots for the two functions overlap in one or more dimensions. For example, an amount of overlap between functions ƒ(x) and g(x) can be computed by determining the value of the integral ∫ƒ(x)·g(x)dx. As another example, if both ƒ(x) and g(x) are positive over the range of values of x that is of interest, then an amount of overlap can be computed by determining the value of the integral ∫min(ƒ(x), g(x))dx. These examples of how an amount of overlap can be computed have been shown for illustration purposes only. Many modifications and variations will be apparent to practitioners having ordinary skill in the art. For example, the one-dimensional integrals shown above can be generalized to multidimensional integrals to compute an amount of overlap in multiple dimensions.

Examples of other factors that can be used for computing the match score are now discussed. A hardware and/or software identifier associated with the device can be used for computing the match score. If it is known that devices that have certain hardware and/or software versions and/or configurations generate more accurate location and/or time information than other devices, then the hardware and/or software identifier can be used to select the probability distribution functions. If a match between two events is expected to be more likely when the corresponding devices have the same type of hardware, then this information can be used during the match score computation. Similarly, the carrier identifier or the network identifier can also be used to select the probability distribution functions and/or adjust the match score. Theses uses of the hardware/software/carrier/network identifiers have been presented for illustration purposes only and are not intended to limit the scope of the embodiments described herein.

In some embodiments described herein, an event may include a network address, e.g., an IP or Ethernet address. Some address spaces are hierarchical, e.g., the IP address space is hierarchical. A match between two events may be expected to be more likely (and the match score may be adjusted accordingly) if the corresponding network addresses are closely related in the address space hierarchy (e.g., if the two network addresses belong to the same subnet).

In some embodiments described herein, an event may include a node identifier in a social network, e.g., the name of the social network (e.g., Facebook) combined with the user name that is used in the social network. The relationship between two users in the social network can be used in the match score computation. For example, if the two users are closely related in the social network (e.g., the distance between the two users in the social network is less than a predetermined hop count), then the match score may be increased (assuming that a higher match score corresponds to a higher likelihood of an event match).

In some embodiments described herein, an event may include a list of locations of the device over a given time period. If it is expected that users who have visited the same location(s) are more likely to exchange information with one another, then the list of locations for two events can be used while computing a match score.

In some embodiments described herein, an event may include an ambient temperature and/or sound recording that was recorded when the event occurred. The ambient temperature and/or sound recording may be used to validate the temporal and spatial information. For example, if the temporal and spatial information from two events indicates that the two events are coincident in time and space, the ambient temperature information and/or sound recording can be used to validate this conclusion.

In some embodiments described herein, an event may include one or more phone numbers (e.g., the device's phone number and/or phone numbers associated with the owner of the device) stored on the device. If it is expected that users who wish to exchange information may have each other's phone numbers stored on their devices and/or have common phone numbers stored on their devices, then these phone numbers can be used during the match score computation.

In some embodiments described herein, an event may include a count of the events that were detected over a given time period. The count of the number of events that a device generates and/or the percentage of such events that end up matching another event can be used for computing and/or adjusting a match score. For example, supposing a device is known to generate a large number of events that do not match any other event, the match score for an event received from this device may be adjusted accordingly (e.g., decreased). On the other hand, if a device rarely generates an event, then a match score for an event received from this device may be adjusted accordingly (e.g., increased).

The past history of event matches can also be used during the match score computation. For example, let us assume that the matching process determines that the matching probability between events E1 and E2 is equal to 0.8, and that the threshold for declaring a match is 0.9. In this case, the matching process may declare that there was no match. Soon thereafter, suppose the matching process receives another request to match events E1 and E2 with essentially the same event information as before. If the matching process does not take the past history of matches into account, then the matching process may again declare that the events did not match (e.g., because the matching probability may again be 0.8). However, in some embodiments described herein, the matching process considers the past history of event matches, and may declare, in this example, that the events matched. Specifically, in some embodiments, the matching process may select a set of match requests for a pair of events that were received over a given time period, e.g., over a predetermined time period (e.g., the last two minutes). Next, the matching process may compute the overall matching probability for the pair of events using the expression 1−π(1−Pᵢ), where Pᵢ is the individual matching probability for the i^{th} match request in the set of match requests. In the above example, the overall matching probability would be 1−((1−0.8)*(1−0.8))=0.96, which would result in a match if we assume that the matching probability threshold is equal to 0.9.

In some embodiments described herein, an event may include a field that indicates the orientation or the amount of tilt in the device when the event was detected. The orientation and/or tilt can be determined based on a measurement from an inertial sensor (e.g., a gyroscope). For example, if the tilt of the device indicates that the user is entering information through a touchscreen, then that may indicate that the movement of the device that triggered the event does not indicate an intention to exchange information with a neighboring device. On the other hand, if the two devices were tilted toward each other when the events were generated, then that may indicate that the users intend to exchange information.

The event detection process and/or the matching process may include a learning aspect. Specifically, some parameters (e.g., weights, thresholds, selection criteria, etc.) that the event detection process and/or matching process use may be learned as the event detection process and/or the matching process execute.

In some embodiments described herein, the device and/or server may modify the parameters (e.g., weights, thresholds, selection criteria, etc.) to reduce the number of false positives and/or false negatives.

In an event detection process, a false positive can occur when the device detects an event even though the user did not intend to exchange information with another user. A false negative can occur when a device does not detect an event even though the user intended to exchange information with another user.

In a matching process, a false positive can occur when a match is declared between two events even though the users did not intend to exchange information. A false negative can occur when a match is not declared between two events even though the users intended to exchange information.

The process shown in FIG. 4 may have a learning aspect. For example, in operation 402, the first device may use one or more thresholds (e.g., an acceleration threshold) to detect the first event based on an action performed by a user using the first device. The first device may modify one more thresholds if the device determines that the first event is a false positive or a false negative. For example, if the first event is a false positive, the first device may increase the value of the acceleration threshold. On the other hand, if the first event is a false negative, the first device may decrease the value of the acceleration threshold. A similar learning approach can be used for modifying other thresholds, weights, and criteria that are used in the event detection process.

The process shown in FIG. 3 may also have a learning aspect. For example, in operation 302, the server can determine a set of devices based on information of an event. Next, in operations 304-306, the server can send a query to each device in the set of devices, and wait for a response (if the timer is still running) from either the entire set of devices or from only a subset of devices.

For example, upon receiving event E1 from device D1, the server can send a query to devices {D2, D3, D4, D5, D6}, and wait until the timer expires or the server receives responses from devices {D2, D3, D4} that are in close proximity to device D1.

In some embodiments described herein, the criteria for selecting the set of devices and/or for selecting the subset of devices can be learned. For example, if the server receives responses from devices D2, D3, and D4 indicating that there were no matching events, then the server may conclude that a match was not found. However, after arriving at this conclusion, if the server receives a response from device D5 which indicates that a match was found, then the server may decide to modify the criteria for selecting the subset (e.g., by increasing the search radius) so that the subset of devices would have included device D5. On the other hand, if it appears that reducing the search radius would not cause the server to miss potential matches, then the server can reduce the search radius to increase performance. A similar learning approach can be used for modifying other thresholds, weights, and criteria that are used in the matching process.

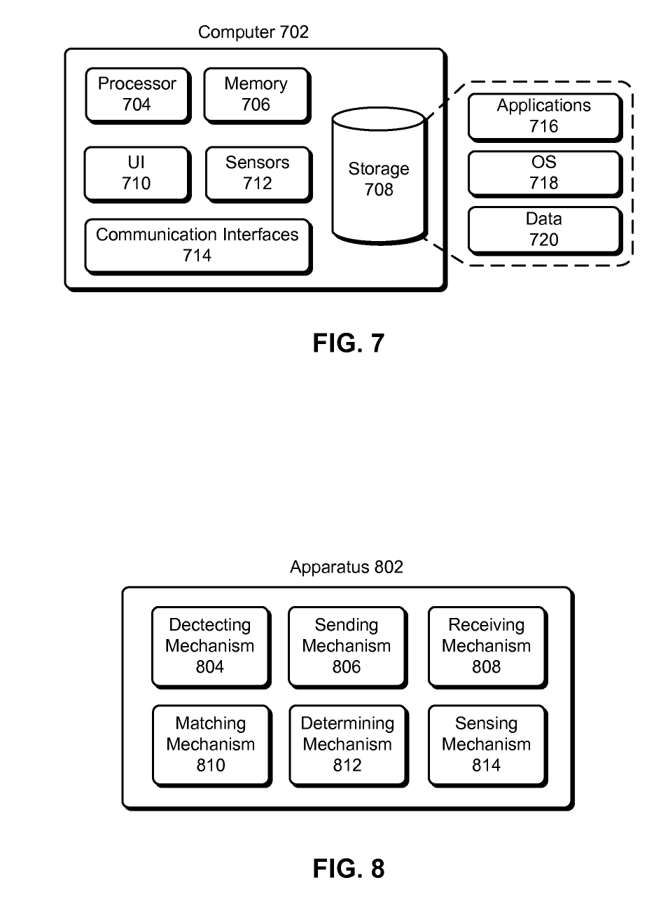

FIG. 7 illustrates a computer in accordance with some embodiments described herein.

A computer can generally refer to any hardware based apparatus that is capable of performing computations. Specifically, devices 104-110 and server 102 shown in FIG. 1 can each be a computer. As shown in FIG. 7, computer 702 can include processor 704, memory 706, user interface 710, sensors 712, communication interfaces 714, and storage 708. User interface 710 can generally include one or more input/output mechanisms for communicating with a user (e.g., a keypad, a touchscreen, a microphone, a speaker, a display, etc.). Sensors 712 can include one or more inertial sensors (e.g., accelerometer, gyroscope, etc.) and/or other types of sensors (e.g., light meters, pressure gauges, thermometers, etc.). Communication interfaces 714 can generally include one or more mechanisms for communicating with other computers (e.g., Universal Serial Bus interfaces, network interfaces, wireless interfaces, etc.). Storage 708 may be a non-transitory storage medium, and may generally store instructions that, when loaded into memory 706 and executed by processor 704, cause computer 702 to perform one or more processes for facilitating communication with another computer. Specifically, storage 708 may include applications 716, operating system 718, and data 720. Applications 716 may include software instructions that implement, either wholly or partly, one or more methods and/or processes that are implicitly and/or explicitly described in this disclosure.

Computer 702 has been presented for illustration purposes only. Many modifications and variations will be apparent to practitioners having ordinary skill in the art. Specifically, computer 702 may include a different set of components than those shown in FIG. 7.

FIG. 8 illustrates an apparatus in accordance with some embodiments described herein.

Apparatus 802 can comprise a number of hardware mechanisms, which may communicate with one another via a wired or wireless communication channel. A hardware mechanism can generally be any piece of hardware that is designed to perform one or more actions. For example, a sending mechanism can refer to transmitter circuitry, and a receiving mechanism can refer to receiver circuitry. In some embodiments described herein, apparatus 802 can include detecting mechanism 804, sending mechanism 806, receiving mechanism 808, matching mechanism 810, determining mechanism 812, and sensing mechanism 814. The apparatus shown in FIG. 8 is for illustration purposes only. Many modifications and variations will be apparent to practitioners having ordinary skill in the art. Specifically, apparatus 802 may include a different set of mechanisms than those shown in FIG. 8. Apparatus 802 can be capable of performing one or more methods and/or processes that are implicitly or explicitly described in this disclosure.

In some embodiments, detecting mechanism 804 may be designed to detect an event based on an action performed by a user. Specifically, detecting mechanism 804 may detect an event based on measurements received from sensing mechanism 814. Sending mechanism 806 may be designed to send information of the event to a server. Receiving mechanism 808 may be designed to receive a response from the server that indicates whether or not the event matched another event that was sent to the server from another apparatus.

In some embodiments, receiving mechanism 808 may be designed to receive information of an event from another apparatus, wherein the event indicates that a user intends to communicate with another user. Matching mechanism 810 may be designed to match the event with one or more events from a set of events based on the information of the event. Sending mechanism 806 may be designed to send a response to another apparatus. In some embodiments, determining mechanism 812 may be designed to determine a set of apparatuses to which a query is to be sent.

The foregoing descriptions of embodiments of the present invention have been presented only for purposes of illustration and description. They are not intended to be exhaustive or to limit the present invention to the forms disclosed. Accordingly, many modifications and variations will be apparent to practitioners having ordinary skill in the art. Additionally, the above disclosure is not intended to limit the present invention. The scope of the present invention is defined by the appended claims.

1-12. (canceled)

13. A non-transitory storage medium storing instructions that, when executed by a computer, cause the computer to perform a method comprising:
receiving, from a first device, information of a first event indicating that a user of the first device intends to communicate with another device;
receiving, from a second device, information of a second event;
responsive to determining that the information of the second event matches the information of the first event, sending a signal to the first device instructing the first device to output information for transmission to the second device;
responsive to determining that information of the second event does not match information of the first event, determining a plurality of devices based on spatial information included in the first event; and
sending a query, the query including one or more criteria based on information of the first event, to each device in the plurality of devices to determine if a device in the plurality of devices has an event that matches the one or more criteria.

14. The non-transitory storage medium of claim 13, wherein the information of the second event indicates that a user of the second device intends to communicate with the first device.

15. The non-transitory storage medium of claim 13, further storing instructions that, when executed by the computer, cause the computer to perform the method, wherein the method further comprises:
responsive to determining that information of the second event does not match information of the first event, adding information of the second event to a set of events comprising information of events that had not been matched with any other event prior to receiving information of the first event.

16. The non-transitory storage medium of claim 13, further storing instructions that, when executed by the computer, cause the computer to perform the method, wherein the method further comprises:
responsive to determining that information of the second event does not match information of the first event, adding the first event to the set of events that had not been matched with any other event prior to receiving information of the first event.

17. (canceled)

18. The non-transitory storage medium of claim 13, further storing instructions that, when executed by the computer, cause the computer to perform the method, wherein the method further comprises:
responsive to sending a query to each device in the set of devices, starting a timer to wait for responses from at least one of the set of devices.

19. The non-transitory storage medium of claim 13, further storing instructions that, when executed by the computer, cause the computer to perform the method, wherein the method further comprises:
responsive to receiving a response from a device in the plurality of devices that indicates the device has an event that matches one or more criteria, sending a signal to the first device instructing the first device to output information for transmission to the device in the plurality of devices.

20. A computer, comprising:
a processor; and
a non-transitory storage medium storing instructions that, when executed by the processor, cause the computer to perform a method for facilitating communication between devices, the method comprising:
receiving, from a first device, information of a first event indicating that a user of the first device intends to communicate with another device;
receiving, from a second device, information of a second event;
responsive to determining that information of the second event matches information of the first event, sending a signal to the first device instructing the first device to output information for transmission to the second device:
responsive to determining that information of the second event does not match information of the first event, determining a plurality of devices based on spatial information included in the first event; and
sending a query, the query including one or more criteria based on information of the first event, to each device in the plurality of devices to determine if a device in the plurality of devices has an event that matches the one or more criteria.

21. The non-transitory storage medium of claim 15, further storing instructions that, when executed by the computer, cause the computer to perform the method, wherein the method further comprises:
responsive to determining that information of the first event matches an event in the set events comprising information of events that had not been matched with any other event prior to receiving information of the first event, sending a signal to the first device instructing the first device to output information for transmission to the device associated with the event in the set of events.

22. The non-transitory storage medium of claim 13, wherein information of a first event comprises first temporal information and information of a second event comprises second temporal information.

23. The non-transitory storage medium of claim 22, wherein determining that the information of the second event matches the information of the first event comprises determining, based on the second temporal information and the first temporal information, that the second event and the first event occurred within a predefined time window.
